(19) United States
(12) Patent Application Publication
(10) Pub. No.: US 2018/0185232 A1
(43) Pub. Date: Jul. 5, 2018

(54) WEARABLE NAVIGATION SYSTEM FOR BLIND OR VISUALLY IMPAIRED PERSONS WITH WIRELESS ASSISTANCE

(71) Applicants: Ashkon Namdar, San Rafael, CA (US); Nader Namdar, San Rafael, CA (US)

(72) Inventors: Ashkon Namdar, San Rafael, CA (US); Nader Namdar, San Rafael, CA (US)

(21) Appl. No.: 14/744,397

(22) Filed: Jun. 19, 2015

(51) Int. Cl. A61H 3/06; H04W 4/024; G06K 9/00; G06F 3/16

(52) U.S. Cl. CPC A61H 3/061; G06F 3/167; G06K 9/00664; H04W 4/024

(57) ABSTRACT

A wearable navigation system for blind or visually impaired persons with wireless assistance. The system has one or more than one camera to capture images from the surroundings of the blind user. A server uses the images captured by the camera along with a global positioning and specialized satellite imagery to determine a route for the blind user to follow. The user uses an audio input/output transceiver to enter and hear commands from the server. The system also has a wireless communications device so that the blind user can ask for remote assistance if there is a situation that the server cannot process.

### FIELD OF THE INVENTION

The present invention relates generally to computer aided visual systems, and more particularly to a wearable navigation system for blind or visually impaired persons with wireless assistance.

### BACKGROUND

According to the U.S. national federation of the blind, there are 6,670,300 blind or visually disable (hereinafter “blind”) people in the U.S. There are a similar number in Europe although the definition of visual impairment is wider compared to U.S. There is a much larger blind population in the rest of the world. Currently, the only practical attempt at creating a semi-independent life for the blind is using the help of a trained guide dog.

Although attempts have been made to use technology to provide some visual aid to blind or visually impaired people, the efforts have fallen short. For example, United States patent number a wearable navigation system for blind or visually impaired persons titled “Portable Blind Aid Device,” claims to aid the blind, but it only works on moving objects. If an object is stationary, then the system fails to operate. Unfortunately, there are a very large number of situations where objects are not moving and this system is useless. There are also problems with low light and other photographic situations where the analysis portion of the invention will not work. In those cases, the blind person is left without any resources so they must rely on traditional blind assistance. This is particularly had if there isn't anyone around to assist the blind person.

Therefore there is a need for a wearable navigation system for blind or visually impaired persons with wireless assistance to travel to various destinations.

### BRIEF DESCRIPTION OF THE DRAWINGS

These and other features, aspects and advantages of the present invention will become better understood with regard to the following description, appended claims, and accompanying figures where:

FIG. 1 is a diagram of a wearable navigation system for blind or visually impaired persons with wireless assistance, according to one embodiment;

FIG. 2 is a diagram of a device useful for the navigation system for blind or visually impaired persons with wireless assistance of FIG. 1;

FIG. 3 is a flowchart diagram of some steps of a method for using the navigation system for blind or visually impaired persons with wireless assistance of FIG. 1; and

FIGS. 4a and 4b is an example of a wearable device useful for the system of FIG. 1.

### SUMMARY

The present invention overcomes the limitations of the prior art by providing a wearable navigation system for blind or visually impaired persons with wireless assistance. The system has one or more than one camera to capture images from the surroundings of the blind user, a server coupled to the one or more than one camera, a global positioning system, specialized satellite imagery accessible by the server, at least one audio input/output transceiver for guiding the blind user with audible commands to a desired destination, and wireless communications.

The server comprises executable instructions to analyze the images taken by the one or more than one camera for object and pattern recognition. A route is determined for the blind user using information from the global positioning system and the specialized satellite imagery. Any voice commands from the blind user are analyzed, and navigation instructions are transmitted to the blind user.

The system analyzes the images to recognize various surfaces and objects along the route and transmit guiding commands to keep the blind user safe. The system analyzes images to recognize objects along the way, moving or still, to alert the blind user to slow down or stop, and provide guiding commands to move the blind user with caution around the obstacles. The various surfaces recognized comprise flat pathways, walkway boundaries, changes in elevation, curbs, stairs, and holes. The various objects comprise bannisters, doors, elevators, escalators, barriers and handrails. The system is configured to issue a command to stop and ask for assistance if any of the various surfaces and objects cannot be analyzed by the system to provide a safe route for the blind user.

In one embodiment, the one or more than one camera, the server, the global positioning system, the specialized satellite imagery and the at least one audio input/output transceiver comprise a single device.

The system further comprises a communications device for sending and receiving information wirelessly and a storage for storing routing information, phone numbers, regular and frequent destinations. The wireless communications device is configured to transmit real time audio commands to the blind user and receive real time audio guidance commands from the blind user. The wireless communications device also transmits audio and images over a wireless communication network to a live assistant to examine the audio and images and talk to the blind user in real time in order to safely guide the user to the destination.

The present invention also comprises a method of using a wearable navigation system for blind or visually impaired persons with wireless assistance. The method comprises the steps of: providing the system. Then, initializing the system. Next, receiving an audible request from a blind user. Then, locating the blind user's position as a starting point. Next, determining an end point destination. Then, calculating a route using specialized satellite imagery and global positioning system data, where the global positioning data comprises the current location and the end point. Next, taking images with the one or more than one camera. Then, processing the images to identify obstacles along the route. Next, generating audible guidance instructions for the route. Finally, repeating the steps above until the destination is reached. The method further comprising the steps of requesting assistance from a live operator. Then, transmitting the images and location information from the system to the live operator for review. And receiving audible instructions from the live operator in response to the request.

There is also provided a wearable navigation device for blind or visually impaired persons. The device comprises one or more than one camera to capture images from the surroundings of the blind user; a server communicatively coupled to the one or more than one camera; a global positioning system communicatively coupled to the server; specialized satellite imagery accessible by the server; at least one audio input/output transceiver communicatively coupled to the server for guiding the blind user with audible commands to a desired destination; and a wireless communications device communicatively coupled to the server. The server on the device comprises executable instructions to: analyze the images using executable instructions on the server for object and pattern recognition; determine a route for the blind user using information from the global positioning system and the specialized satellite imagery; analyze voice commands from the blind user; and transmit navigation instructions to the blind user.

### DETAILED DESCRIPTION

The present invention overcomes the limitations of the prior art by providing navigation system for blind or visually impaired persons with wireless assistance. The navigation system can be used to aid a blind user to independently walk to a destination sending and receiving audible information from the system. The system can comprise one or more than one camera taking still or video images to be used by the system. The system also comprises pattern recognition software capable of defining objects, changes in elevation, sidewalks or flat surfaces with boundaries, doors, stairs, etc. The system also has GPS and can use specialized satellite images to determine pedestrian pathways, sidewalks, and intersections to the destination. The system has voice recognition and is capable of receiving and sending audible commands or prompts to the user. Also, the system can be connected to a live, sighted, person in a remote location that can review the images and can talk to the user in real time if there are any problems.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Systems, methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code that can comprise one or more executable instructions for implementing the specified logical function(s). It should also be noted that, in some alternative implementations, the functions noted in the blocks can occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “Server” refers to one or more than one device with at least one processor configured to transmit, receive and store: instructions executable on the at least one processor; and data from either a local or remote computing device. In some instances the local computing device can also be the server.

The term “specialized satellite imagery” refers to a subset of satellite images that include sidewalks, pedestrian pathways, construction areas and intersections that would be important to a blind user.

Various embodiments provide a wearable navigation system for blind or visually impaired persons with wireless assistance. One embodiment of the present invention provides a wearable device for blind or visually impaired persons with wireless assistance. In another embodiment, there is provided a method for using the system. The system, device and method will now be disclosed in detail.

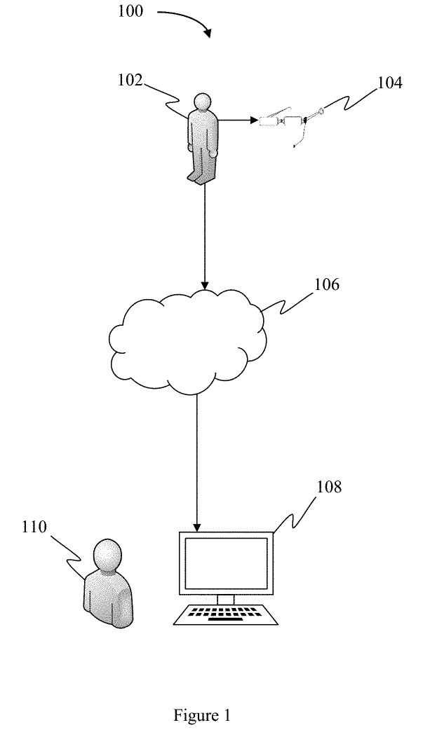

Referring now to FIG. 1, there is shown a diagram of a system for a wearable navigation system for blind or visually impaired persons with wireless assistance, according to one embodiment. The system comprises a wearable device 104 that a blind user 102 can navigate to a destination. The wearable device 104 is connected to a remote server, a local server or to both a remote server and a local server. The wearable device 104 can also comprise a storage for storing executable instructions for the server for determining a route to a destination for the blind user 102. If a situation occurs where the system cannot determine an object or obstacle that isn't in the specialized satellite imagery, the system can issue a “stop and ask for assistance” and connect the blind user 102 to a live operator 110. As will be understood, the live operator can be a paid service, a family member, friend or volunteer. Images taken by the wearable device 104 are transmitted to the live operator 110 so that they can assist the blind user 104 with the situation. The live operator 110 can be part of a paid service or a friend/family member of the blind user 102. The system 100 can also learn and store repeated locations so that the blind user 102 can access them more quickly. The blind user 102 can issue a variety of commands to the system such as:

1. Take me to a coffee shop

2. Take me to 344 Sterling Way, San Rafael

3. Take me to my sister (The system can store names, addresses and phone numbers)

4. Take me to Dr. Joe Smith (If the address is stored)

5. Find the nearest park

6. Go to the closest grocery store

7. Call a taxi

8. Call for help

The system 100 can also issue audible prompts to the blind user 102, such as:

1. Hard stop and wait for further instructions

2. Veer left to stay on the paved path

3. Prepare to turn left

4. Prepare to cross the street

5. Intersection coming up

6. Unknown object, approach with caution

7. Moving object ahead, please wait

8. Rough surface, walk carefully

9. Stairs ahead

10. Identification of various known objects (bicycle, cars, balls, boxes, . . . )

Of course, as will be understood by those with skill in the art, these are examples only and not intended to be limiting.

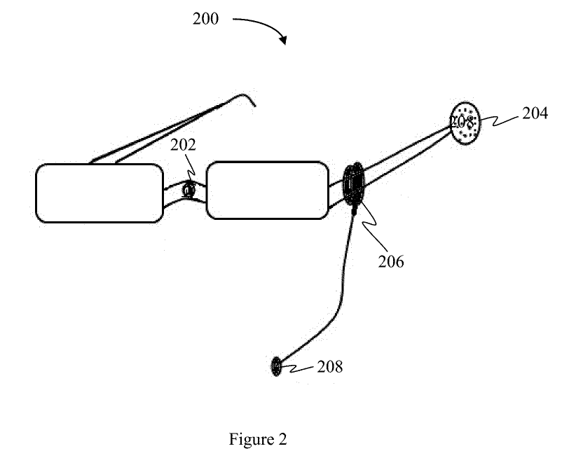

Referring now to FIG. 2, there is shown a diagram of a wearable device 200 useful for the wearable navigation system of FIG. 1. The device 200 comprises one or more than one camera 202 to capture images or videos from the surroundings of the blind user 102. An audio output 204 is located on the device so that the blind user 102 can hear directions or other communications. The device 200 also comprises a server 206 communicatively coupled to the one or more than one camera. The server 206 can be a processor on the device 200 or it can be remotely located. For example, the server 206 can be connected to the device 200 and carried by the blind user in a pocket (not shown), or it can be remotely located and wirelessly accessed by the device 200. The server 206 also has a global positioning system (GPS) communicatively coupled to the server 206. The GPS is typically a microchip that will be understood by those with skill in the art with reference to this disclosure. The server 206 in the device 200 also can access specialized satellite imagery that is used to determine a route for the blind user 102 to get to the desired location. The specialized satellite imagery comprises more detailed information than is normally associated with typical smartphone or automobile GPS units. The specialized satellite imagery Commands can be input into the server 206 using at least one audio input 208 communicatively coupled to the server. The blind user 102 speaks into the audio input 208 to request a destination. The server 206 comprises instructions executable on the server 206 for voice recognition. The blind user 102 speaks a destination into the audio input 208 and the server 206 decodes the information and repeats the destination back to the blind user 102 to insure that the destination is correct. In one case, the blind user 102 can affirm the destination. In another case, no confirmation is necessary if the destination is correct. The blind user 102 can also cancel the destination at any time. For quicker processing, the specialized satellite imagery can be stored in a storage on the device 200. The server 206 then accesses the specialized satellite imagery, stored remotely or locally, and using executable instructions for routing, as is known in the art, issues commands to the blind user 102 to guide them the desired destination. For example, when approaching one or more steps, the system can issue an audible alert such as “Approaching steps” to let the blind user 102 know what the obstacle is so they can properly maneuver. While the blind user 102 is travelling to the destination, the server 206 is processing and analyzing the images taken by the camera 202 to issue warnings to the user. The server 206 comprises executable instructions for pattern recognition of obstacles typically found while walking. For example, similarly to a guide animal, the system 100 can recognize a don't walk signal and issues a command, such as “Don't walk,” to the blind user 102 in plain English. Other useful aspects helpful to the blind user 102, such as handrails, curbs, poles and other items that may not be expected on the route can be identified by the system 100. This provides a more detailed description of the route than can be provided by a service animal.

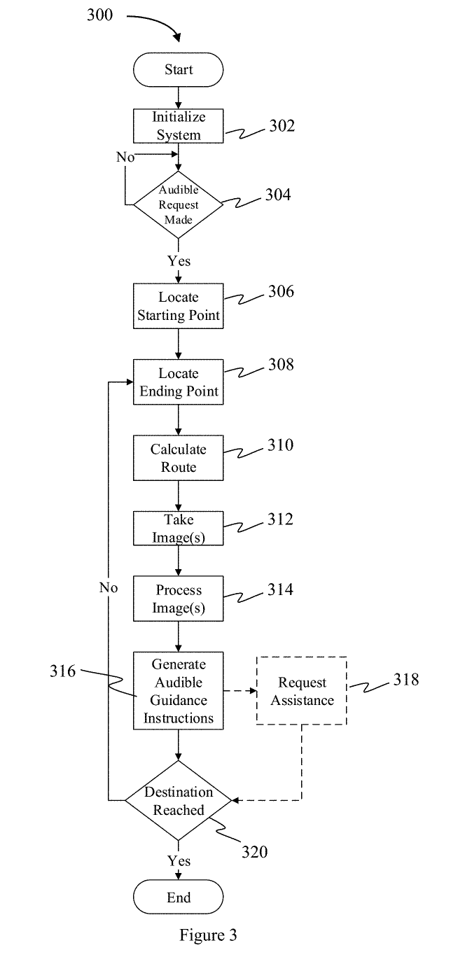

Referring now to FIG. 3, there is shown a flowchart diagram 300 of some steps of a method for using the navigation system for blind or visually impaired persons with wireless assistance of FIG. 1. First, the system 100 is initialized 302. The initialization includes locating all wireless communications available for use by the system 100 and activating the one or more than one camera in preparation for taking images. A basic startup check of all the components of the device 200 are completed to insure proper functioning of the device and the system. Once the user places the device 200 on themselves, then the system 100 checks to see if an audible request has been received 304 from a blind user. Next, the blind user's position is located as a starting point 306 using the GPS portion of the system 100. Then, an end point, or destination, is determined 308 from the audible command received. Next, the system calculates a route 310 using specialized satellite imagery and global positioning system data, where the global positioning data comprises the current location of the blind user and the end point. Then, images are taken 312 with the one or more than one camera and sent for processing by the server 206. Next, the images are processed 314 to identify objects and obstacles along the route. For example, familiar images such as flat sidewalk surfaces, stairs, doors etc. would be well known and defined in the system. Then, audible guidance instructions are generated 316 for the route. Finally, the steps are repeated 320 until the destination is reached.

Optionally, the method also comprises the steps of requesting assistance from a live operator 318. The images and location information are wirelessly transmitted from the system 100 to the live operator for review. Then, audible instructions are received from the live operator 110 in response to the request made by the blind user 102.

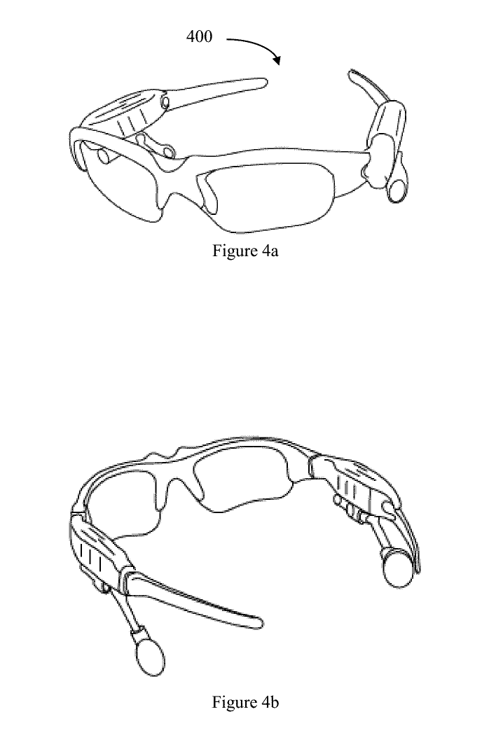

Referring now to FIGS. 4a and 4b, there is shown an example of a wearable device 400 useful for the system 100. As can be seen in this embodiment, the wearable device appears as normal eyewear. However, cameras, transceiver, processor, storage, and communications can be placed inside the wearable device 400. Although, this embodiment is implemented as eyewear, it is understood that there are many other design possibilities for the system depending upon the blind user 102.

What has been described is a new and improved system for a wearable navigation system for blind or visually impaired persons with wireless assistance, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, pit is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A wearable navigation system for blind or visually impaired persons with wireless assistance comprising:
a) one or more than one camera to capture images from the surroundings of the blind user;
b) a server communicatively coupled to the one or more than one camera;
c) a global positioning system communicatively coupled to the server;
d) specialized satellite imagery accessible by the server;
e) at least one audio input/output transceiver communicatively coupled to the server for guiding the blind user with audible commands to a desired destination; and
f) wireless communications communicatively coupled to the server.

2. The system of claim 1, where the server comprises executable instructions to:
a) analyze the images taken by the one or more than one camera using executable instructions on the server for object and pattern recognition;
b) determine a route for the blind user using information from the global positioning system and the specialized satellite imagery;
c) analyze voice commands from the blind user; and
d) transmit navigation instructions to the blind user.

3. The system of claim 1, where the one or more than one camera, the server, the global positioning system, the specialized satellite imagery and the at least one audio input/output transceiver comprise a single device.

4. The system of claim 3 further comprises a storage for storing routing information, phone numbers, regular and frequent destinations.

5. The system of claim 4, where the wireless communications is configured to transmit real time audio commands to the blind user and receive real time audio guidance commands from the blind user.

6. The system of claim 3, where the executable instructions analyze the images to recognize various surfaces and objects moving or still, along the route and transmit guiding commands to alert the blind user to slow down or stop, and provide guiding commands to move the blind user with caution around the obstacles to keep the blind user safe.

7. The system of claim 6, where the various surfaces comprise flat pathways, walkway boundaries, changes in elevation, curbs, stairs, and holes.

8. The system of claim 6, where the various objects comprise bannisters, doors, elevators, escalators, barriers and handrails.

9. The system of claim 6, where the system is configured to issue a command to stop and ask for assistance if any of the various surfaces and objects cannot be analyzed by the system to provide a safe route for the blind user.

10. The system of claim 3, where the wireless communications device transmits audio and images over a wireless communication network to a live assistant to examine the audio and images and talk to the blind user in real time in order to safely guide the user to the destination.

11. A method of using a wearable navigation system for blind or visually impaired persons with wireless assistance, the method comprising the steps of:
a) providing the system of claim 1;
b) initializing the system;
c) receiving an audible request from a blind user;
d) locating the blind user's position as a starting point;
e) determining an end point destination;
f) calculating a route using specialized satellite imagery and global positioning system data, where the global positioning data comprises the current location and the end point;
g) taking images with the one or more than one camera;
h) processing the images to identify obstacles along the route;
i) generating audible guidance instructions for the route; and
j) repeating steps f) through i) until the destination is reached.

12. The method of claim 11 further comprising the steps of:
a) requesting assistance from a live operator;
b) transmitting the images and location information from the system to the live operator for review; and
c) receiving audible instructions from the live operator in response to the request.

13. A wearable navigation device for blind or visually impaired persons comprising:
a) one or more than one camera to capture images from the surroundings of the blind user;
b) a server communicatively coupled to the one or more than one camera;
c) a global positioning system communicatively coupled to the server;
d) specialized satellite imagery accessible by the server;
e) at least one audio input/output transceiver communicatively coupled to the server for guiding the blind user with audible commands to a desired destination; and
f) a wireless communications device communicatively coupled to the server.

14. The device of claim 13, where the server comprise executable instructions to:
a) analyze the images using executable instructions on the server for object and pattern recognition;
b) determine a route for the blind user using information from the global positioning system and the specialized satellite imagery;
c) analyze voice commands from the blind user; and
d) transmit navigation instructions to the blind user.
